(19) United States
(12) Patent Application Publication
(10) Pub. No.: US 2021/0338006 A1
(43) Pub. Date: Nov. 4, 2021

(54) Fully automated cooking pot configured to incorporate and mix ingredients upon user activation.

(71) Applicants: Lial Al-Ahdal, Philadelphia, PA (US); Moneef Bin Break, Philadelphia, PA (US)

(72) Inventors: Lial Al-Ahdal, Philadelphia, PA (US); Moneef Bin Break, Philadelphia, PA (US)

(73) Assignee: LAM Innovations LLC, Philadelphia, PA (US)

(21) Appl. No.: 15/929,431

(22) Filed: May 1, 2020

(51) Int. Cl. A47J 36/32; A47J 36/06; A47J 27/00

(52) U.S. Cl. CPC A47J 36/32; A47J 27/004; A47J 36/06

(57) ABSTRACT

A automatic cooking pot is disclosed. The automatic cooking pot includes a set of compartments, configured to retain one or more ingredients. The automatic cooking pot includes a motor, configured to rotate a first lid and a second lid. The automatic cooking pot includes the first lid and the second lid configured to rotate in a first direction to access the ingredients in the set of compartments, and rotate in a second direction to secure the ingredients in the set of compartments. The automatic cooking pot includes a set of vents configured to seal or unseal the compartments. The automatic cooking pot includes a pot configured to receive, retain, and cook one or more ingredients. The automatic cooking pot includes a heater configured to heat the pot and the one or more ingredients.

### FIELD OF THE INVENTION

The invention relates to a multifunctional cooking system. Specifically, the invention discloses a fully automated cooking pot configured to incorporate and mix ingredients upon user activation.

### BACKGROUND

In today's society, many chef's and private individuals utilize a plethora of different kitchen utensils and various kitchen appliances in order to assist in the preparation and service of food. As many households become busier as they multitask work schedules and family schedules, it has becoming increasingly difficult to prepare meals in an effective cost efficient and time efficient manner. Often the preparer of the meal faces an increasingly difficult time to provide a quality meal while balancing multiple obligations and responsibilities at the same time. In order to avoid spending unnecessary amounts of money that could be caused from eating out or ordering take-out, many families, chef's and preparers are looking for easy ways of preparing a tasty meal, without sacrificing time, and risking the quality of the meal due to a lack of ability to tend to the preparation and cooking process.

Often, most individuals and families turn to a slow cooker, which is commonly known in the art as an example of a combination kitchen utensil which purposefully cooks and warms food at a low temperature for a predetermined period of time. Given its desired capacity to slow cook and warm a modest amount of food, the crock pot is most notably used and observed at large gatherings, such as conferences, receptions, family meetings and so forth.

In accordance with the present invention, applicant has appreciably devised an apparatus comprising a fully automated cooking pot configured to incorporate and mix ingredients upon user activation.

Embodiments of the invention, on the other hand, provide significant advantages while overcoming the above-described and other disadvantages, as will now be described.

### SUMMARY

For the foregoing reasons, there is a need for a versatile automated cooking pot configured to incorporate and mix ingredients upon user activation, that allows for users of the device to automate their cooking and preparation processes. It is further desirable that the cooking pot be configured to incorporate and mix ingredients upon user activation.

In brief summary, the present invention overcomes or substantially alleviate prior art problems related to the provision of automated cooking pot. The primary desirable object of the present invention is to provide relief to homemakers, by alleviating the chore of standing by the stove to cook, stir, modify, or incorporate various ingredients in accordance to a recipe or order of cooking preparation.

In some aspects an automatic cooking pot is described. The automatic cooking pot includes a set of compartments, configured to retain one or more ingredients. The automatic cooking pot includes a motor, configured to rotate a first lid and a second lid. The automatic cooking pot includes the first lid and the second lid configured to rotate in a first direction to access the ingredients in the set of compartments, and rotate in a second direction to secure the ingredients in the set of compartments. The automatic cooking pot includes a set of vents configured to seal or unseal the compartments. The automatic cooking pot includes a pot configured to receive, retain, and cook one or more ingredients. The automatic cooking pot includes a heater configured to heat the pot and the one or more ingredients.

In one embodiment, the set of compartments is configured to extend from above the first lid, downwards towards the pot.

In one embodiment, the automatic cooking pot is controllable by a user via a mobile application via a user device.

In one embodiment, the heat of the heater is set via an initiation time, by setting the temperature, and setting a running time.

In one embodiment, a predetermined time to drop the ingredients is set by setting an initiation time, and/or establishing a compartment number that will drop the ingredients at a predetermined time.

In one embodiment, a time for one or more vents to open is set by setting an initiation time, setting a duration, or establishing the number of vents to open simultaneously or consecutively.

In one embodiment, the mobile application comprises of a warming setting configured to be set automatically or manually once the food is complete.

In one embodiment, one or more recipes is configured to be sent and receive between one or more users via the mobile application.

In one embodiment, the application is configured to open a file with the one or more recipes and immediately initiate cooking.

In one embodiment, at least one vent is configured to be opened to release ingredients into the pot.

In one embodiment, at least two vents are configured to be opened before any ingredients can drop, until all pressure is released.

In one embodiment, a stir function, a heat function, and a vent opening function is configured to be interconnected.

In one embodiment, the one or more compartments are configured to open at a predetermined time.

In one embodiment, the one or more compartments are configured to open in a predetermined order.

In one embodiment, the automatic cooking pot further comprises a removably attached tray oven.

This Summary is provided merely for purposes of summarizing some example embodiments, so as to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

Disclosed herein are embodiments of apparatuses, methods, and systems pertaining to delivering of packages and products from a shipper to a recipient. This description includes drawings, wherein:

FIG. 1A is a side perspective view of the automated cooking pot, in accordance with an example;

FIG. 1B is a top perspective view of the automated cooking pot, in accordance with an example;

FIG. 2 is a cross sectional view of the automated cooking pot, in accordance with an example;

FIG. 3 is an exploded view of the automated cooking pot, in accordance with an example;

FIG. 4 is a top view of the lid portion of the automated cooking pot, in accordance with an example.

FIG. 5 is a perspective view of the heating coil, in accordance with an example.

FIG. 6 is an alternative ingredient mechanism where Number 1 is a micro motor hooked to a gear that pulls the vent back up after dropping ingredients. Number 2 is multiple micro solenoid locking mechanism that releases ingredients and then locks vent after it gets pulled up.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

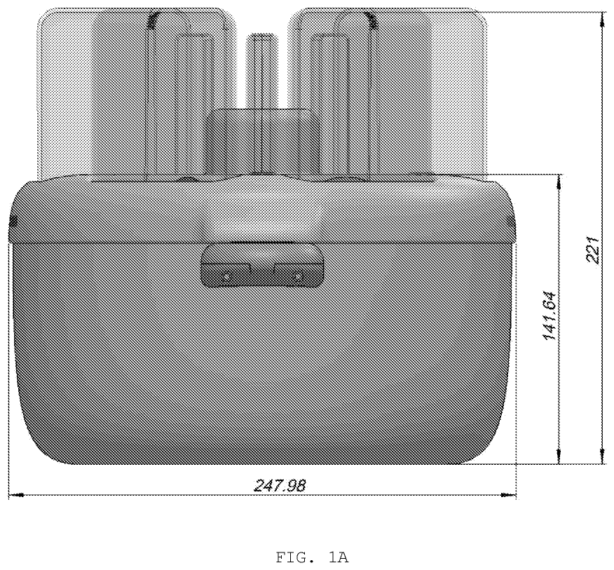

FIGS. 1A and 1B depicts perspective views of the automated cooking pot. The automated cooking pot is configured to drop ingredients into a pot structure and mix them with an indication or activation request received from a user. The premise of the functionality of the automated cooking pot is to provide relief to homemakers and food preparers, of the chose of standing by the stove to cook and prepare ingredients for a meal.

In essence, the automated cooking pot comprises of multiple components that are configured to assist with the food preparation, cooking, and efficient meal preparation in accordance with a user meal, or an associated recipe.

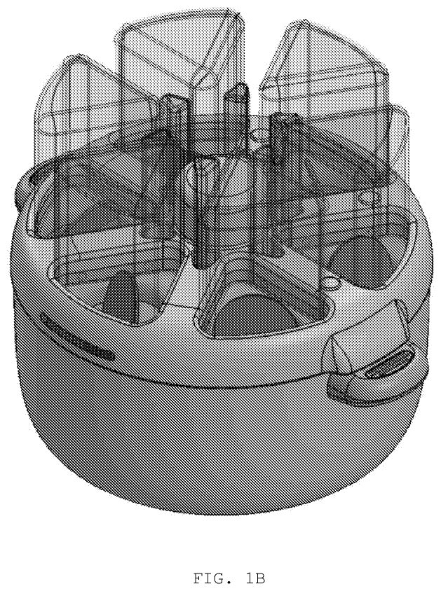

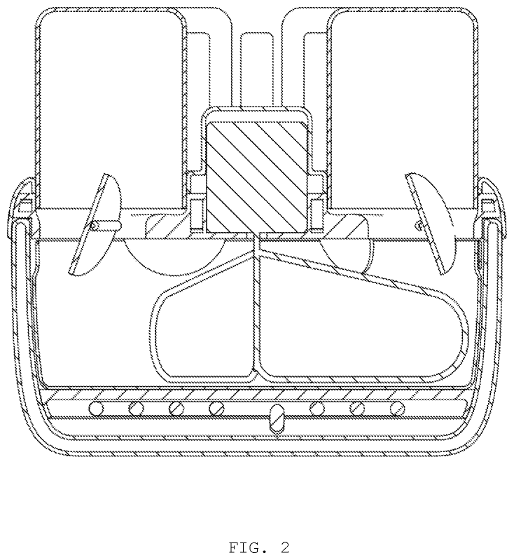

FIGS. 2 and 3 depicts a cross sectional and exploded view of the automated cooking pot, respectively. The automated cooking pot comprises of a set of containers 20. The set of containers can comprise of at least 6 containers configured to hold ingredients that are configured to be included into the prepared meal. Each of the containers 20 are configured to be of a regular size container 20 or a smaller container 15, depending on the size of the ingredients that are to be included into the meal preparation. Each of the containers 15, 20 are connected to a lid 13, that comprises at least 6 openings that are proportionate in size to each of the containers. In order to prepare a meal, ingredients are filled into one or more compartments that are positioned on top of the automated cooking pot. Using a controlling application, via a user device, the user can initiate a programmed recipe automatically, or manually. Below the compartments are plethora of stirrers attached to a stirring mechanism. A user can activate the stirrers to stir the ingredients after they have entered into the pot 6. The stirring mechanism can be configured to stir for a predetermined amount of time, or to be manually activated an deactivated.

Within the lid 13, there can be a set of pressure controllers 22, built in to the top portion of the lid 13. The pressure controllers 22 are configured to be slideably configured to be in an upward position when pressure is being released, and in a downward position when the pressure is being withheld within the automated cooking pot. When pressure is being withheld, the food within the pot is being heated at an even temperature, with an increased pressure, which increases the rate at which the food is being cooked to well done proportions. The pressure in essence are vents that automatically open and close according to a programmed recipe. Built into the lid 13, there can also be a safety vent, that is configured to break if the other vents or pressure controllers 22 fail to operate or open.

Within the bottom portion of the lid 13, a motor 14 is communicatively coupled to the center portion of the lid 13. The motor 14 is configured to rotate a second plastic lid 9, and a PCB 21. The motor 14, is further in communication with the micro metal gear motor bracket 18, that is configured to sustain the motor. The second plastic lid 9 and the PCB 21 are configured to rotate in a first direction to keep the ingredients from entering the automated cooking pot 6, and a second direction to create an opening which allows the ingredients to flow downward toward the meal that is in preparation.

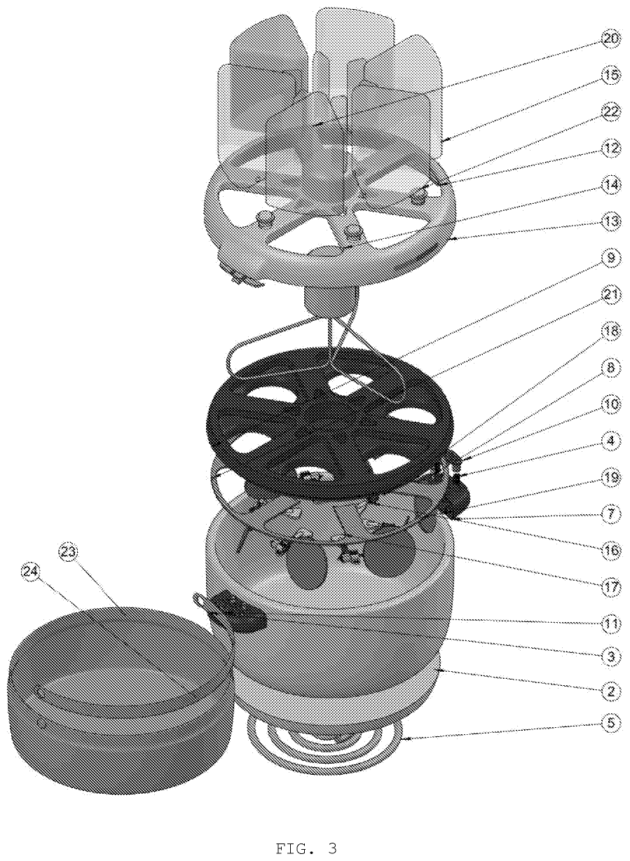

When the ingredients are activated to flow downward into the pot 6, one or more valves, positioned above the pot 6, and preventing contents from entering the pot, are configured to open in order to allow the ingredients to enter the pot 6, as shown in FIG. 4. The ingredients compartment is configured to extend downward towards the pot, with the ability to be within close proximity of the one or more valves. The valves can be configured to open and shut according to the programmed recipe. The valves can be configured to open and shut electronically via an electric mechanism that is programmed via the programmed recipe. The electric mechanism is controlled via a processor, a memory, and configured to connect to a mobile device via a wireless connection or a Bluetooth connection.

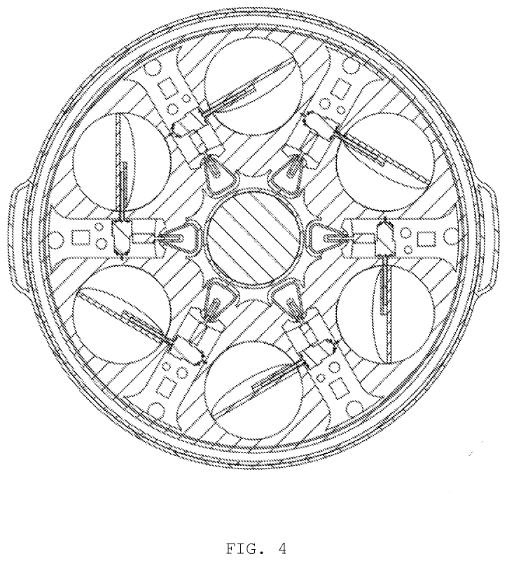

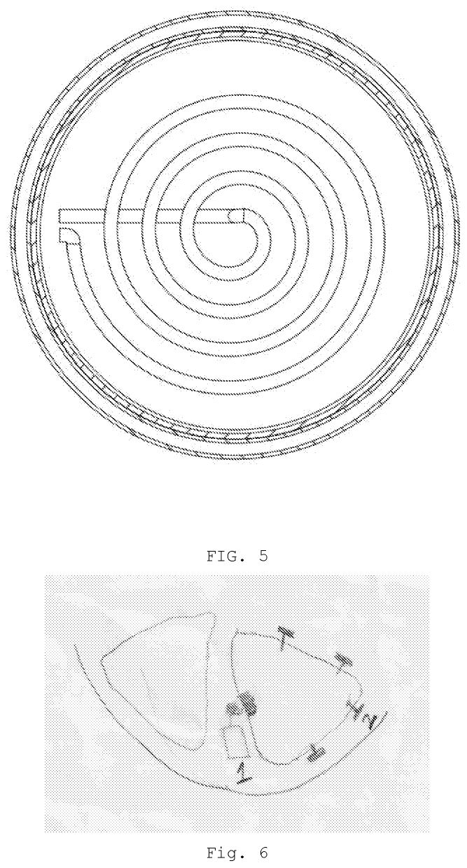

The meal that is in preparation is held within a pot 6, that is concave and with enough cubic inch depth in order to withhold a plethora of different ingredients, meat, vegetables and seasonings. The pot contents are configured to be heated by a heater 5, that is configured to heat the contents at various temperatures that are specified by the user, as shown in FIG. 5. The user can specify the heat of the contents by increasing and decreasing the heater temperature manually, through automatic settings, or through a mobile device that is in communication with the automated heating pot. The pot 6 includes at least two handles 3, 7 that are positioned on either side of the pot 6 in order to ensure a even distribution of weight of the pot 6, when being carried by a user. Each of the handles are secured by one or more pins 8, that are configured to secure the handle to a metal bracket extending from the pot, to support the handles 3, 7. Each of the handles also have one or more handle buttons 10, 11, that are configured to release, or secure the lid 13. The securing of the lid 13, is caused by the lid handle cap 12, that is configured to fasten within the handle 3, 7, in order to lock the lid 13 in place, to prevent the contents within the pot 6, from spilling. The pot is steadied and supported by a pot stand or bottom lid, that is configured to be positioned between the heater 5, and the pot 6. Additionally, within the pot 6, there can be a cooking container 23, that is configured to be removably attached to the pot 6 by a handle 24, with the ability to hold multiple ingredients.

In one embodiment, the automatic cooking pot can be completely controlled via a mobile application on a user device. The user, via the mobile application can set the heat via an initiation time, by setting the temperature, and setting a running time. The user can also set a predetermined time to drop the ingredients by setting an initiation time, and/or establishing a compartment number that will drop the ingredients at a predetermined time. The user can also set a time for the vents to open by setting an initiation time, setting a duration, or establishing the number of vents to open simultaneously or consecutively. Additionally, the user can set the automated cooking pot to a warming setting once the food has completed. The temperature of warming can be set by the user, where the temperature will be maintained until physically opening the pot.

In one embodiment, only compatible orders can be compiled into the process, or a suggestion can be provided by the user.

In one embodiment, the stir function, heat function, and the vent opening function can be interconnected.

In one embodiment, at least two air vents can be configured to be opened before any ingredients can drop, until all pressure is released.

In one embodiment, via the mobile application, recipes can be shared between users via a distinctive file format. The application can be configured to open the file and immediately initiate cooking once the user indicates that they are ready to begin. In all of the recipes the user must identify the contents that are in each compartment (i.e. ½ a potato, 1 fluid ounce of olive oil).

In one embodiment, bottom lid is configured to be washer friendly, and include a detachable compartment that can be used as a tray oven. The tray oven may be configured to bake food such as a cake, fish, or meat. The tray oven is configured to be heated by the heater.

In one embodiment, the cooking pot, and the detachable compartment can be configured to be insulated.

In one embodiment, the top lid can be configured to have at least six wide oval shaped large ingredient compartments, and size small ingredient compartments facing the opposite direction from the large compartments.

In one embodiment, the automatic cooking pot can include a removable decorative cover, that is configured to be large enough to be properly placed on the vents to release steam. Additionally, the ingredient containers can be configured with curved tops, that are shorter towards the outside ring to direct any spills, and to add to product attractiveness.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

Although the present invention has been described in terms of various embodiments, it is not intended that the invention be limited to these embodiments. Modification within the spirit of the invention will be apparent to those skilled in the art.

What is claimed is:

1. An automatic cooking pot comprising:
a set of compartments, configured to retain one or more ingredients;
a motor, configured to rotate a first lid and a second lid,
the first lid and the second lid configured to rotate in a first direction to access the ingredients in the set of compartments, and rotate in a second direction to secure the ingredients in the set of compartments;
a set of vents configured to seal or unseal the compartments;
a pot configured to receive, retain, and cook one or more ingredients; and
a heater configured to heat the pot and the one or more ingredients.

2. The automatic cooking pot of claim 1, wherein the set of compartments is configured to extend from above the first lid, downwards towards the pot.

3. The automatic cooking pot of claim 1, wherein the automatic cooking pot is controllable by a user via a mobile application via a user device.

4. The automatic cooking pot of claim 3, wherein the heat of the heater is set via an initiation time, by setting the temperature, and setting a running time.

5. The automatic cooking pot of claim 3, wherein a predetermined time to drop the ingredients is set by setting an initiation time, and/or establishing a compartment number that will drop the ingredients at a predetermined time.

6. The automatic cooking pot of claim 3, wherein a time for one or more vents to open is set by setting an initiation time, setting a duration, or establishing the number of vents to open simultaneously or consecutively.

7. The automatic cooking pot of claim 3, wherein the mobile application comprises of a warming setting configured to be set automatically or manually once the food is complete.

8. The automatic cooking pot of claim 3, wherein one or more recipes is configured to be sent and receive between one or more users via the mobile application.

9. The automatic cooking pot of claim 3, wherein the application is configured to open a file with the one or more recipes and immediately initiate cooking.

10. The automatic cooking pot of claim 1, wherein at least one vent is configured to be opened to release ingredients into the pot.

11. The automatic cooking pot of claim 10, wherein at least two vents are configured to be opened before any ingredients can drop, until all pressure is released.

12. The automatic cooking pot of claim 1, wherein a stir function, a heat function, and a vent opening function is configured to be interconnected.

13. The automatic cooking pot of claim 1, wherein the one or more compartments are configured to open at a predetermined time.

14. The automatic cooking pot of claim 1, wherein the one or more compartments are configured to open in a predetermined order.

15. The automatic cooking pot of claim 1, further comprising a removably attached tray oven.
